(19) United States
(12) Patent Application Publication
(10) Pub. No.: US 2011/0075579 A1
(43) Pub. Date: Mar. 31, 2011

(54) Method and apparatus for delay management in wireless communication

(76) Inventors: James Paul Seymour, North Aurora, IL (US); Subramanian Vasudevan, Morristown, NJ (US)

(21) Appl. No.: 12/655,530

(22) Filed: Dec. 31, 2009

Related U.S. Application Data
(60) Provisional application No. 61/277,850, filed on Sep. 30, 2009.

(51) Int. Cl. H04L 12/26

(52) U.S. Cl. 370/252

(57) ABSTRACT

A method is provided for determining an allowed delay budget for the air interface portion of a communications link, the communications link comprising one or more air interface portions and a network portion. In particular, the method of the invention operates in a wireless communication system comprising an air interface portion and a network portion, and includes (1) determining a network delay for calls in the system on a per-call basis; and (2) apportioning an air-link delay budget for ones of calls in the system so as to maintain approximately equal total delay for all calls.

### RELATED APPLICATIONS

This application claims priority pursuant to 35 U.S.C. Sec 119(e) to U.S. Provisional Application No. 61/277,850, filed Sep. 30, 2009, entitled “METHOD AND APPARATUS FOR DELAY MANAGEMENT IN WIRELESS COMMUNICATION,” the subject matter thereof being fully incorporated herein by reference.

### FIELD OF THE INVENTION

The present invention generally relates to management of delay in a communications path.

### BACKGROUND OF THE INVENTION

Many communications services require that end to end transmission delay be kept within a particular bound to assure an acceptable quality of service. For wireless communication services, the end-to-end transmission delay includes both the delay over the wireless link (air interface) of the communications path and the delay over the network (or land-line) portion of the communications path. The overall delay limit for a particular application being a known quantity, the allowed delay for either the air-interface portion or the network portion of the end-to-end communication link may be determined as a difference between the overall delay limit and an allowed delay for the other portion.

Thus, in many wireless applications, an estimate of the network delay is used to infer air-interface delay budget requirements on a per-user/per-service basis. These air-interface delay budgets are incorporated in the air-interface scheduling algorithm and used to format the transmission over the air-interface. The air-interface delay budget has a direct impact on the maximum system capacity, maximum coverage and/or best user experience (e.g. voice quality) that is achievable. Larger air-interface delay budgets allow the scheduler to perform more HARQ retransmissions and to more optimally schedule users during “good” channel conditions (e.g., by being able to postpone the scheduling of users in a deep fades).

In the current art, the air-interface delay budget that the scheduler uses is fixed for all users regardless of the network delays they experience, and therefore worst case assumptions for network delays are assumed. This results in the air-interface delay budget for users who do not experience the worst case network delays being set unnecessarily short, leading to degradation in coverage and/or capacity.

### SUMMARY OF INVENTION

A method is provided for determining an allowed delay budget for the air interface portion of a communications link, the communications link comprising one or more air interface portions and a network portion. In particular, the method of the invention operates in a wireless communication system comprising an air interface portion and a network portion, and includes (1) determining a network delay for calls in the system on a per-call basis; and (2) apportioning an air-link delay budget for ones of calls in the system so as to maintain approximately equal total delay for all calls.

I particular embodiments, the invention methodology takes advantage of the availability of per user network delays at the base station scheduler to increase system capacity, improve individual user service (e.g., voice) quality, and/or extend the range of the transmission (coverage extension). This is done by the scheduler setting long air-interface delay budgets for users with short network delays, and short air-interface delay budgets for users with long network delays (so that the overall air-interface plus network delay for all users is similar). The delay-management capability of the invention can be built into the system in a manner that allows it to adapt autonomously, without operator intervention, to the location of the communicating parties and the service being used, such as voice, gaming, or video sharing.

### BRIEF DESCRIPTION OF THE FIGURES

The teachings of the present invention can be readily understood by considering the following detailed description in conjunction with the accompanying drawings, in which:

FIG. 1 depicts a system architecture in which the method of the invention may be implemented.

### DETAILED DESCRIPTION

In the following description, for purposes of explanation and not limitation, specific details are set forth such as particular architectures, interfaces, techniques, etc., in order to provide a thorough understanding of illustrative embodiments of the invention. However, it will be apparent to those skilled in the art that the invention may be practiced in other illustrative embodiments that depart from these specific details. In some instances, detailed descriptions of well-known devices, circuits, and methods are omitted so as not to obscure the description of described embodiments with unnecessary detail. All principles, aspects, and embodiments, as well as specific examples thereof, are intended to encompass both structural and functional equivalents thereof. Additionally, it is intended that such equivalents include both currently known equivalents as well as equivalents developed in the future.

The invention is described hereafter in terms of delay management for calls that both originate and terminate with a wireless terminal, and transit a network portion of the communications link between the two wireless portions of that communications link. It should be clear, however, that the invention will be applicable to delay management for calls having a wireless connection at only one end of the total communications link, and that the use the illustrative case of a wireless origination and termination in the description following is solely for purposes of illustrating the invention principles, and is not in any way intended to limit the scope of the invention.

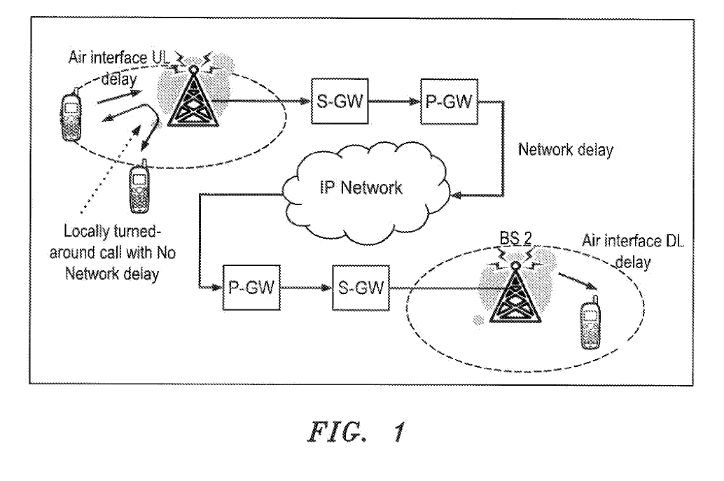

FIG. 1 illustrates several mobile to mobile calls with the associated delays incurred over the respective air-interfaces (uplink from the mobile to the base station and downlink from the base station to the mobile) and the network (source base station to destination base station via the core network) delay.

It is important to note that such network delays are variable depending on the location of the two base stations and the path traversed within the core network. For instance, some base stations may be only tens of miles apart, and service mobile-to-mobile calls without any long distance exchange (and thus have small network delays), while other base stations could be thousands of miles apart and service long distance mobile-to-mobile calls (e.g. a call between a mobile in New York and another mobile in California), which would have larger network delays.

It is also known that different services such as voice, gaming, or video streaming have different maximum delay bounds, beyond which the user experience for the service is impaired. It is critical, therefore, to keep the net end-to-end air-interface delay plus network delay within these bounds.

A method is described herein by which an estimate of the aggregate network delay can be utilized by the air-interface scheduling and resource allocating entities to ensure that the end-to-end delay budgets are adhered to for all users.

### System Operation

The methodology of the invention takes advantage of the characteristic of wireless packet data systems wherein schedulers, typically located at base stations, are employed to adjudicate the competing demands for air interface resources from various users. These schedulers use radio-link related information (e.g., channel quality), buffer size (numbers of packets and their sizes for each user), and deadlines based on service type, to time and format the transmissions to each user.

Both link adaptation (i.e., the choice of transmission time, transmission duration and transmission frequencies) and re-transmission techniques (e.g., HARQ) are used to ensure that the air interface resources used to transfer each bit of data to the end user are minimized, while also meeting minimum service quality requirements.

Referring back to FIG. 1, two scenarios are considered for a mobile to mobile voice call. In the first scenario, the communicating users are under the coverage area of the same base station (e.g., user 1 and user 2). In the second scenario, the communicating users are assumed to be in different cities (e.g., user 1 and user 3).

In case 1, the bearer traffic can be turned around at the base station itself incurring zero network delay. In case 2, a network delay associated with the intervening network elements and long-distance wired transmission facilities is incurred.

Illustratively, the associated network delays in the two cases are therefore on the order of 0 and 40 milliseconds, respectively. As can be seen from this illustrative case, the network delays can vary significantly depending on the location of the two communicating terminals.

In a system implemented according to the invention, the network delay is estimated at call set-up for each call and used on a per user basis in the base station scheduler to define the allowable air-interface delay (uplink+downlink) per user.

The estimate of network delay can be based on the location of the communicating users and the type of communication (voice, video share, gaming) from which an entity in the network can infer the route taken by the traffic between these paths. Certain traffic nodes can, for example, be dedicated for the support of certain traffic types. The network topology, i.e. the length of the route and the number of traffic processing nodes along the route, as well as the traffic load on the individual segments making up the route, can be used to estimate the net delay incurred by traffic flowing on the chosen route. Such information pertaining to the network layout and load can be provisioned in a network database with periodic refinements based on observed network performance.

Again considering the illustrative case of FIG. 1, and assuming, for example, that the maximum tolerable one way delay for a voice call to be 150 ms, it can be seen that 150 and 110 milliseconds, respectively, are available to accommodate delay in the over-the-air portion of the transmission link (i.e., total air interface delay from one mobile to the base station and from the base station to the other mobile) in the case 1 and case 2 scenarios.

Recognizing that air-interface delay in the described embodiment has two components (uplink delay and downlink delay), the system will coordinate between the two base stations to determine the allowed delay budget for each air-interface link, insuring that the overall end-to-end delay budget is not exceeded. Illustratively, the system could implement this allocation between the two air-interface portions via an algorithm arranged to always allow only one link (either downlink or uplink) to take advantage an extra air-interface delay allowance (due to a smaller network delay) by increasing the air-interface delay budget for the selected air-interface link. Alternatively, the allocation of extra air-interface delay allowance between the two air-interface portions may be implemented by provisioning the two base station schedulers to communicate with each other and to negotiate an appropriate apportioning of the aggregate air-interface delay budgets. Depending on the load at its cell, one of the base station schedulers may request a larger fraction of the allowed delay budget.

As an example, based on current per-link delay budgets, allowed uplink delay may be 1.5 times of allowed downlink delay. Thus, for the illustrative case described above, ⅖^{th} of the illustrative 150 and 110 ms (equaling 60 and 44 milliseconds for the two cases) will be provided for downlink transmission and ⅗^{th} of 150 and 110 ms (equaling 90 and 66 ms) will be provided for uplink transmission. Since there is an additional 40 ms of delay budget available for the users communicating via the same base stations (i.e., users 1 and 2), this additional 40 ms delay could be added to the downlink (allowing for 44+40=84 ms downlink air-interface delay budget) or the uplink (allowing for 66+40=104 ms uplink delays budget) or split between uplink and downlink (for example, using a 64 ms downlink delay budget and an 84 ms uplink delay budget).

In the described embodiment, the apportioning of delay budget, as illustrated above, is made at the base station schedulers on a per-user, per-call, per-service basis. It should, however, be understood that such apportionment function can be carried out by other entities at the base station, or by other nodes in the wireless system.

The methodology of the invention, as described above, may advantageously be applied to use the available air-interface delay budget to meet voice quality, coverage or capacity objectives. Those applications are described hereafter.

### Voice Quality

The current wireless-system scheduler operation assigns a fixed air-interface delay budget for all transmissions based on a service class (Quality-of-Service Class Index). Typically this fixed per-service delay budget is determined based on worst case network delay projections.

According to the invention methodology, the air-interface scheduler operation is modified by increasing the air-interface delay budgets for users with small network delays, even within the same service class. Note that for many real-time, delay sensitive applications (e.g., voice), while there is a maximum delay budget that must be adhered to, there is also little benefit to reducing the delay materially below the acceptable delay budget. For example, a 150 ms delay budget for voice insures that the perceived delays are small enough to prevent double talk. Reducing the delay budget below 150 ms has minimal perceived benefits (since the 150 ms delay was already small enough to not be perceived). Thus, if the network delays are actually only 110 ms for a given user, an additional 40 ms of delay budget can be introduced to the uplink and/or downlink air-interface scheduler for this user, thereby, for example, increasing the maximum number of HARQ retransmissions for this user, and accordingly increasing the number of successfully transmitted speech frames, thus improving voice quality. All this is accomplished without any perceptual delay increase by the user because the end-to-end delay budget was kept below 150 ms.

### Coverage Extension

In every wireless system, there are always coverage holes due to the challenges of achieving wide area contiguous coverage in a mobile environment. In current wireless systems, some of these coverage holes may be unnecessary for certain users due to the air-interface delay budget being set based on the worst case network delay. If certain users in such coverage-hole areas are experiencing smaller than the worst case network delays, then this can be used by the scheduler to increase the air-interface delay budget, thereby increasing the number of HARQ retransmission for this user, thus improving the ability for this user to receive voice/data packets in this area, and thereby improving coverage.

Further, in the cases where additional air-interface delay tolerance is available for nearly all users (for example in a campus or enterprise setting with intra-campus or intra-enterprise calls), one can increase the number of HARQ transmissions per packet and thereby reduce the transmit power of each transmission for all users. On the uplink, this will enable users that are close to cell edge and otherwise power limited to close the link with the base station.

### Capacity Gain

When additional air-link delay budget is available, there is also an opportunity to increase system capacity. As discussed above, increasing the air-interface delay budget increases the opportunities for the scheduler to schedule users at favorable channel conditions which directly increases system capacity. In addition, the number of HARQ transmissions can be increased to reduce use of system resources and thereby spreading these resources over a larger pool of users.

Herein, the inventors have disclosed a method for improved delay management for calls carried over a transmission link including one or more air-interface portions and a network portion. Numerous modifications and alternative embodiments of the invention will be apparent to those skilled in the art in view of the foregoing description.

Accordingly, this description is to be construed as illustrative only and is for the purpose of teaching those skilled in the art the best mode of carrying out the invention and is not intended to illustrate all possible forms thereof. It is also understood that the words used are words of description, rather that limitation, and that details of the structure may be varied substantially without departing from the spirit of the invention, and that the exclusive use of all modifications which come within the scope of the appended claims is reserved.

1. A method in a wireless communication system comprising:
determining a network delay for calls in the system on a per-call basis; and
apportioning an air-link delay budget for ones of calls in the system so as to maintain approximately equal total delay for all calls
